(19) United States
(12) Patent Application Publication
(10) Pub. No.: US 2024/0092152 A1
(43) Pub. Date: Mar. 21, 2024

(54) VEHICULAR LAMINATED GLASS AND VEHICULAR WINDOW STRUCTURE

(71) Applicant: AGC Inc., Tokyo (JP)

(72) Inventors: Yuhei GIMA, Tokyo (JP); Yukihiro Sumi, Tokyo (JP); Satoshi Kaneko, Tokyo (JP)

(73) Assignee: AGC Inc., Tokyo (JP)

(21) Appl. No.: 18/516,786

(22) Filed: Nov. 21, 2023

Related U.S. Application Data
(63) Continuation of application No. PCT/JP22/20991, filed on May 20, 2022.

(30) Foreign Application Priority Data
May 25, 2021 (JP) 2021-087419
Jul. 15, 2021 (JP) 2021-117142

(51) Int. Cl. B60J 3/04; B32B 17/10; B60J 1/00; B60J 1/17; B60J 5/04

(52) U.S. Cl. CPC B60J 3/04; B32B 17/10036; B32B 17/10504; B32B 17/10761; B60J 1/001; B60J 1/17; B60J 5/0402; E05D 15/165

(57) ABSTRACT

A vehicular laminated glass, which has a first glass plate and a second glass plate facing each other, an interlayer between the first glass plate and the second glass plate, and a light control film capable of switching the visible light transmission provided inside the interlayer, which further has a lower edge portion to which wiring to the light control film is connected, an upper edge portion facing the lower edge portion, and side edge portions connecting the upper edge portion and the lower edge portion, wherein the first glass plate has a first main surface located on the opposite side to the interlayer and a second main surface facing the interlayer, the second glass plate has a third main surface facing the interlayer and a fourth main surface located on the opposite side to the interlayer, which has a first shielding layer between the first main surface and the light control film.

This application is a continuation of PCT Application No. PCT/JP2022/020991, filed on May 20, 2022, which is based upon and claims the benefit of priority from Japanese Patent Application No. 2021-087419 filed on May 25, 2021 and Japanese Patent Application No. 2021-117142 filed on Jul. 15, 2021. The contents of those applications are incorporated herein by reference in their entireties.

### TECHNICAL FIELD

The present invention relates to vehicular laminated glass and a vehicular window structure.

### BACKGROUND ART

As vehicular window glass such as automobiles, trains, etc., laminated glass having a light control film capable of switching the visible light transmittance, is known. The light control film is, for example, a film of liquid crystal or electroluminescent element, and is sealed, for example, in an interlayer sandwiched between two glass plates (see, for example, Patent Document 1).

In such laminated glass, the peripheral portion of the light control layer inside the light control film may deteriorate due to moisture or impact. Therefore, it is arranged so that the periphery of the light control film is positioned inside in the plane direction than the periphery of the glass plates. However, in such an arrangement, the periphery of the light control film is visible from inside and outside of the vehicle, whereby the appearance as viewed from inside and outside of the vehicle will deteriorate.

Therefore, to prevent the periphery of the light control film from being seen from inside and outside the vehicle, a shielding layer may be provided, for example, on the inside surface of the glass plate located on the outside side of the vehicle or on the inside surface of the glass plate located on the inside side of the vehicle.

### PRIOR ART DOCUMENT

### Patent Document

Patent Document 1: WO2007/142319

### DISCLOSURE OF INVENTION

### Technical Problem

However, when the above-mentioned laminated glass is applied to sliding glass such as side door glass of a vehicle, the durability against sliding deteriorates, if a shielding layer is provided on the inside surface of the glass plate located on the inside of the vehicle. Specifically, when laminated glass slides repeatedly, the shielding layer on the inside face of the glass plate located on the inside side of the vehicle wears out due to the contact with the glass run.

The present invention was made in view of the above-mentioned points, and is intended to improve the durability against sliding, as well as to prevent deterioration of the appearance as viewed from the inside and outside of the vehicle, in the vehicular laminated glass having a light control film.

### Solution to Problem

Vehicular laminated glass according to one embodiment of the disclosure is vehicular laminated glass, which has a first glass plate and a second glass plate facing each other, an interlayer between the first glass plate and the second glass plate, and a light control film inside the interlayer capable of switching the visible light transmittance, which has a lower edge portion to which wiring to the light control film is connected, an upper edge portion opposing to the lower edge portion, and side edge portions connecting the upper edge portion and the lower edge portion, wherein the first glass plate has a first main surface located on the opposite side to the interlayer and a second main surface facing the interlayer, and the second glass plate has a third main surface facing the interlayer and a fourth main surface located on the opposite side to the interlayer, which has a first shielding layer provided between the first main surface and the light control film, and a second shielding layer provided on the fourth main surface; at least one of the side edge portions and the upper edge portion has a transmitting portion at the peripheral portion of the fourth main surface, and at least a part of the second shielding layer is located inside in the plane direction than the transmitting portion, and in a plan view of the second glass plate, the periphery of the light control film at the upper edge portion overlaps the second shielding layer.

Vehicular laminated glass according to another embodiment of the disclosure is vehicular laminated glass, which has a first glass plate and a second glass plate facing each other, an interlayer between the first glass plate and the second glass plate, and a light control film capable of switching the visible light transmittance, provided inside the interlayer, which further has a lower edge portion to which wiring to the light control film is connected, an upper edge portion opposing to the lower edge portion, and side edge portions connecting the upper edge portion and the lower edge portion, wherein the first glass plate has a first main surface located on the opposite to the interlayer and a second main surface facing the interlayer, and the second glass plate has a third main surface facing the interlayer and a fourth main surface located on the opposite side to the interlayer, which has a first shielding layer between the first main surface and the light control film, and a second shielding layer on the fourth main surface, and which has the following structure A or structure B, wherein in a plan view of the second glass plate, the periphery of the light control film at the upper edge portion, overlaps the second shielding layer,
Structure A: at least one of the side edge portions and the upper edge portion has a transmitting portion provided at the peripheral portion of the fourth main surface, and
at least a part of the shielding portion or semi-shielding portion formed by the second shielding layer, is located inside in the plane direction than the transmitting portion,
Structure B: the second shielding layer has a semi-shielding portion from the periphery of the fourth main surface toward the inside in the plane direction.

### Advantageous Effects of Invention

According to one embodiment of the disclosure, in vehicular laminated glass having a light control film, deterioration of the appearance as viewed from inside and outside of a vehicle can be suppressed and durability against sliding can be improved.

### BRIEF DESCRIPTION OF DRAWINGS

FIGS. 1A and 1B are views illustrating laminated glass according to the first embodiment.

FIG. 2 is a partially enlarged view in the vicinity of the upper edge portion of the laminated glass (No. 1).

FIG. 3 is a partially enlarged view in the vicinity of the upper edge portion of the laminated glass (No. 2).

FIG. 4 is a view illustrating a glass run.

FIG. 5 is a partially enlarged view illustrating another example in the vicinity of the upper edge portion of laminated glass (No. 1).

FIG. 6 is a partially enlarged view illustrating another example in the vicinity of the upper edge portion of laminated glass (No. 2).

FIG. 7 is a partially enlarged view illustrating another example in the vicinity of the upper edge portion of laminated glass (No. 3).

FIGS. 8A and 8B are views illustrating laminated glass according to a modified example of the first embodiment.

FIG. 9 is a schematic view illustrating a window structure for a vehicle.

### DESCRIPTION OF EMBODIMENTS

In the following, with reference to the drawings, embodiments to carry out the present invention will be described. There may be a case where in the respective drawings, to the same components, the same symbols are attached, and duplicate explanations may be omitted. Further, there may be a case where, in the respective drawings, the size and shape of some parts may be exaggerated to facilitate understanding of the contents of the present invention.

Here, the term “vehicle” is used to refer to any mobile vehicle that can be equipped with laminated glass, including a train, a ship, an aircraft, etc., although the most common vehicle is an automobile.

Further, a plan view means viewing an object from the direction of the normal line passing through the center of gravity of the object's main surface, and the shape visible at that time is called a plane shape.

Further, the designations “upper” and “lower” shall refer to the upper and lower when the laminated glass is installed on a vehicle. In addition, references to “upper edge portion” and “lower edge portion” shall, respectively, refer to the area of a predetermined width including the upper edge and the area of a predetermined width including the lower edge, when the laminated glass is installed on a vehicle, and references to “side edge portion” shall refer to the area of a predetermined width including at least one of the right side edge and the left side edge, when the laminated glass is installed on a vehicle.

Further, the outer edge in a plan view of a predetermined member is called “periphery”, and, in a predetermined member, the area having a width in contact with the periphery is called “peripheral portion”. The “peripheral portion” is a term including the upper edge portion, the lower edge portion, and the side edge portions. When the laminated glass is reduced with the center of gravity of the laminated glass as the center, the peripheral portion may be the area between the “periphery” before reduction and the “periphery” after reduction. The reduction ratio is, for example, from 99% to 70%, and may be 95%, 90%, 80%, or 75%.

### [Laminated Glass]

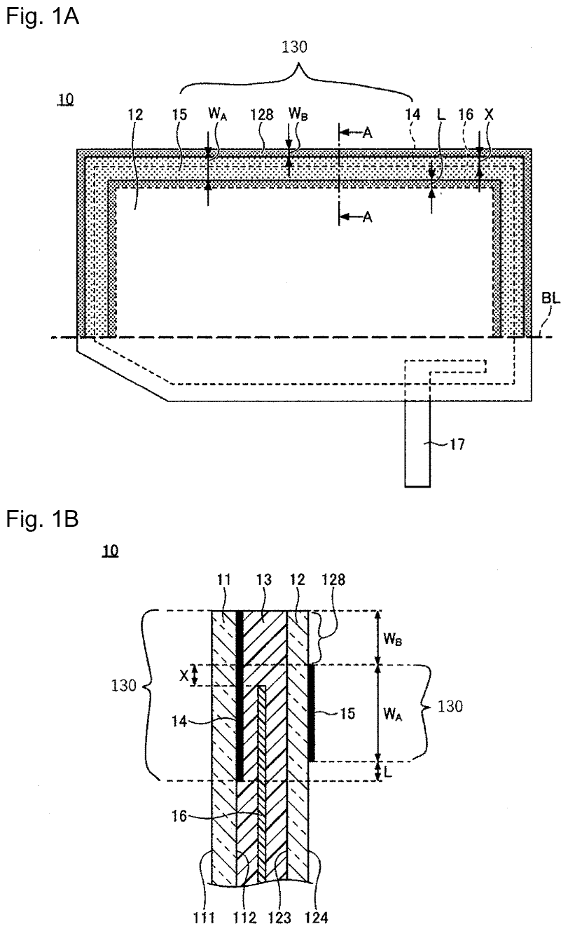

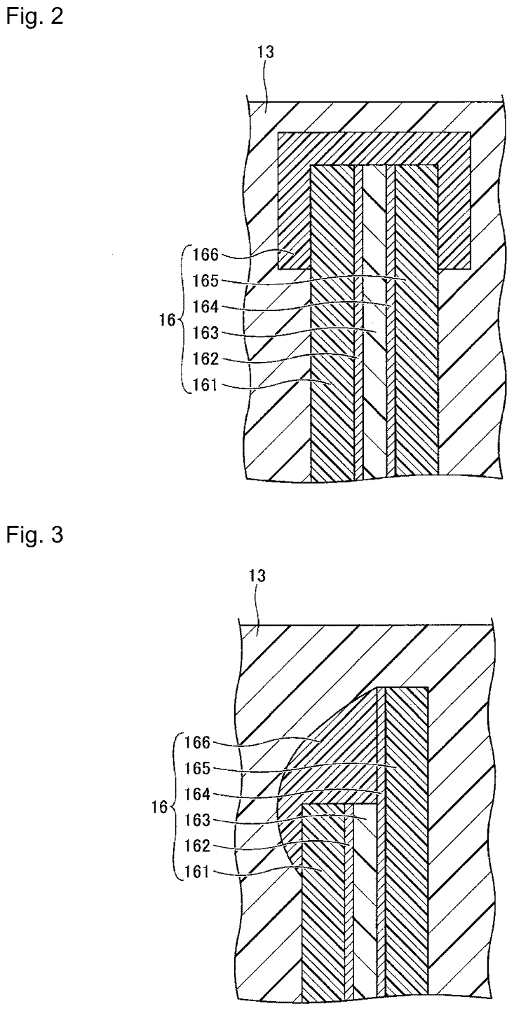

FIGS. 1A and 1B are views illustrating laminated glass 10 according to the first embodiment. FIG. 1A is a view schematically showing the state when the laminated glass is viewed from the normal direction of the second glass plate, and FIG. 1B is a partially enlarged cross-sectional view along line A-A in FIG. 1A.

As shown in FIG. 1B, the laminated glass 10 is vehicular laminated glass having a first glass plate 11, a second glass plate 12, an interlayer 13, a first shielding layer 14, a second shielding layer 15, and a light control film 16. The laminated glass 10 has a lower edge portion, which is located on the lower side when the laminated glass 10 is installed on a vehicle, an upper edge portion, which is located on the upper side when the laminated glass 10 is installed on a vehicle, opposite to the lower edge portion, and a pair of side edge portions connecting the lower edge portion and the upper edge portion. FIG. 1B shows a cross-sectional view in the vicinity of the upper edge portion of the laminated glass 10.

The first glass plate 11 and the second glass plate 12 are bonded via an interlayer 13. The first glass plate 11 is positioned on the first side, which is the exterior side when the laminated glass 10 is installed on a vehicle, and the second glass plate 12 is positioned on the second side, which is the interior side when the laminated glass 10 is installed on a vehicle.

In FIGS. 1A and 1B, for convenience of explanation, the actual curved shape of the laminated glass 10 is omitted, and the external shape is simplified. However, the laminated glass 10 may have not only the flat (non-curved) shape as shown in FIG. 1A but also the curved shape. The laminated glass 10 may be, for example, mono-curved in one of the vertical or horizontal direction when mounted on a vehicle, or double-curved in both vertical and horizontal directions when mounted on a vehicle. However, the mono-curved and double-curved shapes are not limited to the vertically and/or horizontally curved shapes when mounted on a vehicle. The mono-curved shape includes a shape curved in only one direction. Further, the double curved shape includes a shape curved in any two or more different directions.

In a case where the laminated glass 10 is curved, the laminated glass 10 is preferably curved so that it becomes convex toward the outside of the vehicle. That is, the first glass plate 11 is preferably curved so that it becomes convex toward the opposite side of the interlayer 13, and the second glass plate 12 is preferably curved so that it becomes convex toward the interlayer 13 side. Here, in FIG. 1A, in a plan view, the laminated glass 10 is shown to be substantially in a rectangular shape, but the laminated glass 10 is not limited to be substantially in a rectangular shape and may be of any optional shape. The term “substantially” here means that no geometrical rigor is required in terms of linearity, number and size of corners, etc. The laminated glass 10 may be substantially in a trapezoidal shape, substantially in a triangular shape, and so on. Here, in a case where the laminated glass 10 is substantially in a triangular shape, the laminated glass 10 has one side edge and one side edge portion.

The laminated glass 10 may be used as vehicular window glass or as a partition in vehicles. As vehicular window glass, the laminated glass 10 may be used, for example, as a windshield, a rear window, a quarter window, a roof, and an extra window. Further, among vehicular window glass, the laminated glass 10 is suitable for use as a window glass slidable in an up-and-down direction. As such window glass, for example, front side door glass and rear side door glass of automobiles may be mentioned.

The beltline BL in FIG. 1A is the boundary line between the laminated glass 10 and the door panel of the vehicle when the laminated glass 10 is installed on the vehicle. FIG. 1A schematically shows the positional relationship between the laminated glass 10 and the beltline BL, in a state when the laminated glass 10 slidable in an up-and-down direction, is fully closed (in a state located at the uppermost position).

The first glass plate 11 has a first main surface 111 on the opposite side to the interlayer 13 and a second main surface 112 on the side of the interlayer 13. The second glass plate 12 has a third main surface 123 on the interlayer 13 side and a fourth main surface 124 on the opposite side to the interlayer 13. When the laminated glass 10 is installed on a vehicle, the first main surface 111 will be the surface located on the most exterior side of the vehicle, and the fourth main surface 124 will be the surface located on the most interior side.

In a case where the laminated glass 10 is curved, the minimum value of the radius of curvature of the laminated glass 10 is preferably at least 500 mm and at most 100,000 mm. The radii of curvature of the first glass plate 11 and the second glass plate 12 may be the same or different. If the radii of curvature of the first glass plate 11 and the second glass plate 12 are different, the radius of curvature of the second glass plate 12 is smaller than that of the first glass plate 11.

The first glass plate 11 and the second glass plate 12 are a pair of glass plates facing each other, and the interlayer 13 and the light control film 16 are located between the pair of glass plates. The first glass plate 11 and the second glass plate 12 are fixed in a state having the interlayer 13 and the light control film 16 sandwiched between them. The interlayer 13 is a film to bond the first glass plate and the second glass plate.

In the laminated glass 10, at least at the upper edge portion, the peripheral side surface of the interlayer 13 is exposed. Therefore, the peripheral side surface of the interlayer 13 is preferably edge-treated. That is, the peripheral side surface of the interlayer 13 is preferably treated so that it does not substantially protrude from the peripheral side surfaces of the first glass plate 11 and the second glass plate 12. When the protrusion amount of the peripheral side surface of the interlayer 13 from the peripheral side surfaces of the first glass plate 11 and the second glass plate 12 is at most 1 mm, it is preferred in that it does not spoil the appearance. The protrusion amount of the peripheral side surface of the interlayer 13 from the peripheral side surfaces of the first glass plate 11 and the second glass plate 12 is more preferably at most 0.5 mm, further preferably at most 0.15 mm.

The peripheral side surface of the interlayer 13 may be embedded inwardly from the peripheral side surfaces of the first glass plate 11 and the second glass plate 12. When the embedded amount of the peripheral side surface of the interlayer 13 into the peripheral side surfaces of the first glass plate 11 and the second glass plate 12 is within 3 mm, it is preferred in that it does not impair the strength of the laminated glass. The embedded amount of the peripheral side surface of the interlayer 13 into the peripheral side surfaces of the first glass plate 11 and the second glass plate 12 is more preferably within 2 mm, further preferably within 1 mm. Details of the first glass plate 11, the second glass plate 12 and the interlayer 13 will be described later.

The first shielding layer 14 is an opaque layer, and e.g. at least at the upper edge portion of the laminated glass 10, it is provided between the first main surface 111 and the light control film 16. The first shielding layer 14 may be provided only on the upper edge portion of the laminated glass 10, or may be provided on one or both of the side edge portions in addition to the upper edge portion of the laminated glass 10. If the first shielding layer 14 is provided on both side edge portions of the laminated glass 10, the first shielding layer 14 may be provided only on the upper side above the belt line BL. However, the first shielding layer 14 may extend below the belt line BL on both side edge portions of the laminated glass 10.

The first shielding layer 14 may form a shielding portion 130 as shown in FIGS. 1A and 1B, and may partially or wholly form a semi-shielding portion. Similarly, the second shielding layer 15 described below may also form a shielding portion 130 as shown in FIGS. 1A and 1B, and may partially or wholly form a semi-shielding portion. That is, the shielding portion 130 and the semi-shielding portion are, respectively, formed by at least one of the first shielding layer 14 and the second shielding layer 15. The shielding portion 130 provides a shielding effect on all portions within a given region. Further, the semi-shielding portion provides the shielding effect in a part of the given region. That is, the shielding portion 130 does not include the dot areas nor stripe areas as described below, while the semi-shielding portion includes the dot areas, stripe areas, etc. as described below.

In the example of FIG. 1A, the first shielding layer 14 is provided on the second main surface 112 at the upper edge portion of the laminated glass 10. Further, both ends of the first shielding layer 14 provided on the upper edge portion in a plan view of the first glass plate 11 are extended to both side edge portions of the laminated glass 10 and only on the upper edge portion side than the belt line BL.

The second shielding layer 15 is an opaque layer, and e.g. at least at the upper edge portion of the laminated glass 10, it is provided on the fourth main surface 124. At the upper edge portion of the laminated glass 10, in a plan view of the second glass plate 12, the distance L between the lower edge portion (inner edge) of the second shielding layer 15 and the lower edge portion (inner edge) of the first shielding layer 14 is, for example, at least 0 mm and at most 10 mm. When the distance L is at most 10 mm, the shielding layer is less noticeable, such being preferred because it is easier to ensure good visibility. The distance L may be at most 8 mm or at most 6 mm. Further, when the distance L is at least 0 mm, the boundary between the inner edge of the first shielding layer 14 and the inner edge of the second shielding layer 15 is hardly visible from inside and outside of the vehicle. When the distance L is more than 0 mm, it is preferred in that the influence of the distortion (see-through distortion) generated at the boundary between the area where the shielding layer is provided and the area where no shielding layer is provided, can be reduced, and the distance L is more preferably at least 1 mm, further preferably at least 2 mm.

The distance L is not limited to the case where the inner edge of the first shielding layer 14 is located below (in-plane) the inner edge of the second shielding layer 15, as illustrated in FIG. 1B, but is the same also in the case where the inner edge of the second shielding layer 15 is located below (in-plane) the inner edge of the first shielding layer 14. In such a case, the distance L may be measured in a plan view of the first glass plate 11 instead of a plan view of the second glass plate 12.

At the upper edge portion of the laminated glass 10, the width W_{A} of the second shielding layer 15 is preferably at least 3 mm and at most 35 mm. When the width W_{A} of the second shielding layer 15 is at least 3 mm, the peripheral portion of the light control film 16 can be sufficiently shielded. When the width W_{A} of the second shielding layer 15 is at most 35 mm, the deterioration of the appearance caused by the second shielding layer 15 can be suppressed. At the upper edge portion of the laminated glass 10, the width W_{A} of the second shielding layer 15 is more preferably at least 5 mm, further preferably at least 8 mm, still more preferably at least 10 mm, particularly preferably at least 15 mm. Further at the upper edge portion of the laminated glass 10, the width W_{A} of the second shielding layer 15 is more preferably at most 30 mm. Within such a range, the peripheral portion of the light control film 16 can be more reliably shielded. Further, the width W_{A} of the second shielding layer 15 may not be constant, but may be partially varied. In a case where the width W_{A} of the second shielding layer 15 is partially varied, it is preferably gently varied.

The second shielding layer 15 may be provided only on the upper edge portion of the laminated glass 10, but may be provided on one or both of the side edge portions in addition to the upper edge portion of the laminated glass 10. In a case where the second shielding layer 15 is provided on both side edge portions of the laminated glass 10, the second shielding layer 15 may be provided only on the upper edge portion side than the belt line BL. However, the second shielding layer 15 may extend to the lower edge portion side than the belt line BL on both side edge portions of the laminated glass 10.

In the example in FIG. 1A, the second shielding layer 15 is provided on the upper edge portion of the laminated glass 10 on the fourth main surface 124, and further, both ends of the second shielding layer 15 provided on the upper edge portion in a plan view of the second glass plate 12, extend to both side edge portions of the laminated glass 10 and only on the upper edge portion side than the belt line BL.

In the second glass plate 12, a transmitting portion 128 is provided at the peripheral portion of the fourth main surface 124. The transmitting portion 128 is a portion where the fourth main surface 124 is exposed at the peripheral portion of the fourth main surface 124. However, the portion where the fourth main surface 124 is exposed in the dot area and the stripe area (i.e., gaps between dots and stripes), which will be described later, is not included in the transmitting portion 128. The second shielding layer 15 is located on the lower side than the transmitting portion 128 at the upper edge portion of the laminated glass 10. The periphery of the second shielding layer 15 is in contact with the transmitting portion 128.

In the example in FIG. 1A, the shielding portion 130 is formed by the first shielding layer 14 and the second shielding layer 15. More precisely, the shielding portion 130 is formed by only the first shielding layer 14 in the portion overlapping the transmitting portion 128 in the plan view of the first glass plate 11, and by the first shielding layer 14 and the second shielding layer 15 in the portion not overlapping the transmitting portion 128 (on the lower side than the transmitting portion 128).

In the upper edge portion of the laminated glass 10, the width W_{B} of the transmitting portion 128 is preferably at least 5 mm and at most 25 mm. When the width W_{B} of the transmitting portion 128 is at least 5 mm, the second shielding layer 15 provided on the upper edge portion can be prevented from contacting the glass run at the time when the laminated glass 10 is used as a sliding window. When the width W_{B} of the transmitting portion 128 is at most 25 mm, the deterioration of the appearance as viewed from the inside of the vehicle by the second shielding layer 15 can be prevented. At the upper edge portion of the laminated glass 10, the width W_{B} of the transmitting portion 128 is more preferably at most 20 mm, further preferably at most 15 mm, still more preferably at most 10 mm. Within such a range, the deterioration of the appearance as viewed from the inside of the vehicle due to the second shielding layer 15 can be further suppressed. Further, the width W_{B} of the transmitting portion 128 may be at least 6 mm, at least 7 mm, or at least 8 mm. Further, the width W_{B} of the transmitting portion 128 may not be constant, but may be partially varied. In a case where the width W_{B} of the transmitting portion 128 is partially varied, it is preferably gently varied.

In a case where the second shielding layer 15 is provided on one or both of the side edge portions, the width of the transmitting portion 128 may be at least 0 mm and at most 3 mm at the side edge portion where the second shielding layer 15 is provided. At the side edge portion where the second shielding layer 15 is provided, the width of the transmitting portion 128 may be at most 2 mm, or at most 1 mm. That is, in a case where the second shielding layer 15 is provided on one or both of the side edge portion portions, the transmitting portion 128 may not be provided at the side edge portion where the second shielding layer 15 is provided.

The reason why it is not necessary to provide a transmitting portion 128 at the side edge portion where the second shielding layer 15 is provided, is that even if the second shielding layer 15 at the side edge portion is damaged by contact with the glass run during lifting and lowering, the second shielding layer 15 at the side edge portion is not visible from inside the vehicle because it is not exposed from the glass run.

However, since sliding noise may be generated when the second shielding layer 15 slides against the glass run, a transmitting portion 128 with a width sufficient to avoid contact with the glass run may be provided also at the side edge portion. In such a case, the width W_{B} of the transmitting portion 128 at the side edge portion of the laminated glass 10 is preferably at least 5 mm and at most 25 mm. When the width W_{B} of the transmitting portion 128 is at least 5 mm, the second shielding layer 15 provided on the side edge portion can be prevented from contacting the glass run, when the laminated glass 10 is used as a sliding window. Therefore, the scratch resistance of the laminated glass 10 will be improved. When the width W_{B} of the transmitting portion 128 is at most 15 mm, the deterioration of the appearance as viewed from the inside of the vehicle by the second shielding layer 15 can be suppressed. At the side edge portion of the laminated glass 10, the width W_{B} of the transmitting portion 128, is more preferably at most 20 mm, further preferably at most 15 mm, still more preferably at most 10 mm. Within such a range, the deterioration of the appearance as viewed from the inside of the vehicle by the second shielding layer 15 can be further suppressed. So far, an example has been shown in which at least at the upper edge portion of the laminated glass 10, the second shielding layer 15 is located on the lower side (in-plane) than the transmitting portion 128. However, without being limited to this, only at one or both of the side edge portions of the laminated glass 10, the second shielding layer 15 may be located on the inside in the vehicle than the transmitting portion 128. For example, at the side edge portions of the laminated glass 10, the width W_{B} of the transmitting portion 128 may be at least 5 mm and at most 25 mm, and at the upper edge portion, the width W_{B} of the transmitting portion 128 may be at most 3 mm. In such a case, at the upper edge portion, the width W_{B} of the transmitting portion 128 may be at most 2 mm or at most 1 mm.

In the examples in FIGS. 1A and 1B, in the plan view of the second glass plate 12, the periphery of the light control film 16 at the upper edge portion of the laminated glass 10 overlaps the first shielding layer 14. Further, in the plan view of the second glass plate 12, the periphery of the light control film 16 at the upper edge portion of the laminated glass 10 overlaps the second shielding layer 15. In this way, the peripheral portion of the light control film 16 can be prevented from being seen from the inside and the outside of the vehicle.

The first shielding layer 14 is preferably disposed at a position where in a plan view of the second glass plate 12, it overlaps all of the transmitting portion 128. That is, the periphery of the first shielding layer 14 preferably coincides with the periphery of the second main surface 112 of the first glass plate 11. In this way, the peripheral portion of the light control film 16 can be surely prevented from being seen from the outside of the vehicle. However, the first shielding layer 14 may not overlap all of the transmitting portion 128 in the plan view of the second glass plate 12, and, in other words, it may overlap a part of the transmitting portion 128 and may have a narrower gap than the transmitting portion 128 at the peripheral portion of the second main surface 112 of the first glass plate 11. That is, the distance from the periphery of the first shielding layer 14 to the periphery of the first glass plate 11 may be less than 5 mm, preferably at most 2 mm, more preferably at most 1 mm.

The first shielding layer 14 and the second shielding layer 15 are, for example, opaque colored ceramic layers, and their colors may be optional, but a dark color such as black, brown, gray, dark blue or the like, or white, is preferred, and a black color is more preferred. The first shielding layer 14 and the second shielding layer 15 may be colored films having light-shielding properties, or a combination of a colored film and a colored ceramic layer. The colored film may be integrated with an infrared reflection film or the like. Further, in the interlayer 13, at least the part located on the outside of the vehicle than the light control film 16, may also be made to be a colored interlayer. In such a case, the colored interlayer located on the exterior side of the vehicle than the light control film 16 will function as the first shielding layer 14.

The width of the first shielding layer 14 in a plan view is, for example, at a level of from 10 mm to 100 mm. The width of the first shielding layer 14 in a plan view is more preferably at least 20 mm. The width of the first shielding layer 14 in a plan view is further preferably at most 80 mm, still more preferably at most 60 mm, particularly preferably at most 50 mm, most preferably at most 40 mm. By the presence of the opaque first shielding layer 14 in the laminated glass 10, it is possible to hide any deterioration of the peripheral portion of the light control film 16. Further, even when an adhesive made of a resin such as urethane is used to hold the peripheral portion of the laminated glass 10 to the vehicle body, it is possible to suppress the deterioration of the adhesive due to ultraviolet rays.

The first shielding layer 14 and the second shielding layer 15 may be formed, for example, by applying a ceramic color paste containing fusible glass frit containing a black pigment on a glass plate by screen printing, etc. and baking it. However, the method for forming the first shielding layer 14 and the second shielding layer 15 is not limited to this method. The first shielding layer 14 and the second shielding layer 15 may be formed, for example, by applying an organic ink containing a black or dark pigment on a glass plate by screen-printing, etc. and then drying it.

The light control film 16 is an element capable of switching the visible light transmittance of the laminated glass 10. At the lower edge portion of the laminated glass 10, the light control film 16 is connected to the wiring 17 for supplying a power to the light control film 16 from the outside of the laminated glass 10. When a voltage is applied to the light control film 16 from a power source such as a battery via the wiring 17, the visible light transmittance of the light control film 16 will be switched according to the applied voltage. Note that even when the laminated glass 10 is installed on a vehicle and the laminated glass 10 is completely closed, the wiring 17 is located below the belt line BL. Therefore, the wiring 17 is not visible when the laminated glass 10 is installed on the vehicle.

The light control film 16 is sealed inside the interlayer 13. That is, the light control film 16 is surrounded by the interlayer 13. The flat surface of the light control film 16 is smaller than that of the laminated glass 10. That is, the periphery of the light control film 16 is located inside in the plane direction than the periphery of the second main surface 112 of the first glass plate 11 and the periphery of the third main surface 123 of the second glass plate 12.

The light control film 16 comprises, for example, two transparent substrates with conductive layers facing each other and a light control layer disposed between the two transparent substrates. The light control layer is at least one to be selected from, for example, a suspended particle device, a polymer dispersion type liquid crystal, a polymer network liquid crystal, a guest host liquid crystal, photochromic, electrochromic, and electrokinetic. The light control layer is preferably at least one to be selected from a suspended particle device, a polymer dispersion type liquid crystal, a polymer network liquid crystal, and a guest host liquid crystal. The thickness of the light control film 16 is, for example, at least 0.1 mm and at most 1 mm. The thickness of the light control film 16 may be at most 0.8 mm, or at most 0.5 mm. The thickness of the light control film 16 may be at least 0.3 mm.

As shown in FIG. 2, the light control film 16 includes a light control layer 163 disposed between a transparent substrate 161 with a conductive layer 162 and a transparent substrate 165 with a conductive layer 164, and the peripheral side surface may be sealed with a sealing material 166. The sealing material 166 is a resin or an adhesive tape. Sealing means surrounding at least the peripheral side surface of the light control layer 163 by the specified sealing material 166 so that the peripheral side surface of the light control layer 163 does not come into contact with air or the interlayer 13. By sealing the peripheral side surface of the light control film 163, it is possible to suppress deterioration that occurs at the peripheral portion of the light control film 163. As the resin, a curable resin of e.g. acrylic type, epoxy type or a silicone type, is suitable. The curable resin may be a resin which is curable by heat-, light-, or moisture, or a resin of a two-liquid curable system consisting of a main material and a curing agent. The color of the curable resin is preferably transparent, but not limited to transparent, it may also be black or white. As the base material for the adhesive tape, polyethylene terephthalate (PET), polyethylene, polypropylene, polyimide, polycarbonate, polyvinyl chloride, polytetrafluoroethylene or the like, is preferred. As the adhesive material for the adhesive tape, a resin of acrylic type, silicone type, urethane type or the like, is suitable.

As shown in FIG. 3, the dimensions of the transparent substrate 161 with a conductive layer 162 and the transparent substrate 165 with a conductive layer 164 facing each other, may be different. Specifically, one of the transparent substrate 161 with a conductive layer 162 and the transparent substrate 165 with a conductive layer 164 may be larger than the other, and may be so-called “half-cut,” meaning that the peripheral portions do not overlap in a plan view. It is preferred for the peripheral portion of the light control film 16 to be half-cut in order to make it easier to hold the film after applying the curable resin that will serve as the sealing material 166.

The sealing width of the light control film 16 in a plan view is preferably at least 2 mm and at most 20 mm. By setting the sealing width to be at least 2 mm, it is possible to sufficiently suppress deterioration of the edges of the light control film. By setting the sealing width to be at most 20 mm, it is possible to reduce deterioration in appearance caused by the first shielding layer 14 and the second shielding layer 15.

In the plan view of the second glass plate 12, the distance X (see FIG. 1B) between the periphery of the second shielding layer 15 (the periphery on the outside in-plane) and the periphery of the light control film 16 at the upper edge portion of the laminated glass 10 is preferably at most 10 mm. When the distance X is at most 10 mm, it is possible to suppress deterioration of the appearance as viewed from the inside of the vehicle due to the second shielding layer 15. In the plan view of the second glass plate 12, the distance X may be 0 mm. The distance X may be positive in the inside direction in-plane from the outside direction in-plane. That is, at the upper edge portion of the laminated glass 10, the distance X is preferably at least 0 mm. Here, the distance X may be applied to the side edge portions of the laminated glass 10 as the case requires.

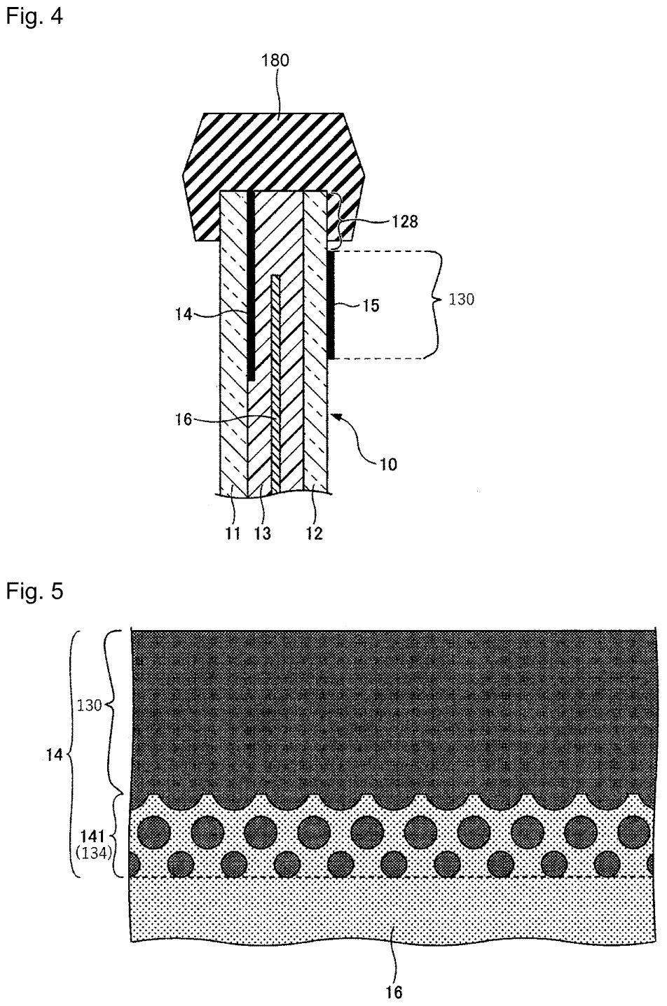

FIG. 4 is a view illustrating a glass run. The glass run 180 shown in FIG. 4 is a sealing component made of e.g. a resin to be attached to the window frame of a vehicle, and it seals the gap between the laminated glass 10 and the window frame of the vehicle to prevent noise, wind, rain, etc. from entering into the vehicle. The glass run 180 is provided in contact with the upper edge portion and both side edge portions of the laminated glass 10, and the two side edge portions of the laminated glass 10 are raised and lowered while being held by the glass run 180. In the following, the description will be made mainly with respect to the upper edge portion of the laminated glass 10, but may be applied to one or both of the side edge portions as well. When the laminated glass 10 is moved to the uppermost position by sliding, as shown in FIG. 4, the upper edge portion of the laminated glass 10 is held by the glass run 180. Even when the laminated glass 10 is moved to the uppermost position by sliding, the second shielding layer 15 does not touch the glass run 180. In other words, the glass run 180 will be in contact with only the transmitting portion 128, among the transmitting portion 128 of the fourth main surface 124 of the second glass plate 12, and the second shielding layer 15. The portion where the glass run 180 will be in contact with only the transmitting portion 128 among the transmitting portion 128 of the fourth main surface 124 of the second glass plate 12 and the second shielding layer 15, may be only the upper edge portion, may be one or both of the side edge portions, or may be one or both of the upper edge portion and the side edge portions.

Thus, in the laminated glass 10, at the upper edge portion, a transmitting portion 128 is provided at the peripheral portion of the fourth main surface 124 of the second glass plate 12. And, the width W_{B} of the transmitting portion 128 is set so that the second shielding layer 15 does not touch the glass run 180 even when the laminated glass 10 is moved to the upper most portion. This prevents the second shielding layer 15 from being damaged by abrasion when it rubs against the glass run 180 at the upper edge portion of the laminated glass 10, even if the laminated glass 10 is repeatedly raised and lowered after being installed on a vehicle. That is, when the laminated glass 10 is used as sliding glass, the durability against sliding can be improved. The laminated glass 10 is subjected to rubbing against the glass run 180 for a long time and frequently at the portion parallel to the sliding direction. Therefore, when one or both of the side edge portions of the laminated glass 10 is provided with a transmitting portion 128 and the portion of the second shielding layer 15 provided on one or both of the side edge portions of the laminated glass 10 does not touch the glass run 180 when the laminated glass 10 is sliding, the scratch resistance of the laminated glass 10 will be improved.

Further, in the laminated glass 10, the first shielding layer 14 is provided between the first main surface 111 of the first glass plate 11 and the light control film 16 at the upper edge portion. As a result, the periphery of the light control film 16 is not visible from the outside of the vehicle, and thus, it is possible to suppress the deterioration of the appearance as viewed from the outside of the vehicle.

Further, in the laminated glass 10, the second shielding layer 15 is provided inside in-plane of the transmitting portion 128 on the fourth main surface 124 of the second glass plate 12 so that it overlaps with the periphery of the light control film 16 at the upper edge portion of the laminated glass 10 as viewed in-plane of the second glass plate 12. As a result, the periphery of the light control film 16 is not visible from the inside of the vehicle, and thus, it is possible to suppress the deterioration of the appearance as viewed from the inside of the vehicle. Note that the overlap here includes the case where X=0 in FIG. 1B.

Further, in the laminated glass 10, the width W_{A} [mm] of the second shielding layer 15 and the above-mentioned distance X [mm] preferably satisfy W_{A}−X≥5. It is thereby possible that even if the peripheral portion of the light control film 16 is deteriorated over time, the deteriorated portion can be shielded, thereby preventing deterioration of the appearance as viewed from the inside of the vehicle. The deterioration of the light control film 16 over time is caused by the penetration of moisture or components of the interlayer 13 from the periphery to the inside of the light control film 16. As a result of a study, the present inventors have found that the color tone changes in the deteriorated portion of the light control film 16, but the growth of the width of the deteriorated portion is saturated at a certain point and does not widen further. Therefore, by providing the second shielding layer 15 so as to satisfy W_{A}−X≥5, it is possible to shield the deteriorated portion of the light control film 16 even after a lapse of time.

From the viewpoint of shielding the deteriorated portion of the light control film 16, the value of W_{A}−X may be at least 5. If the value of W_{A}−X becomes too large, the width of the second shielding layer 15 becomes excessively wide, and the visibility as vehicle glass is reduced. Therefore, the value of W_{A}−X is preferably, for example, at most 35.

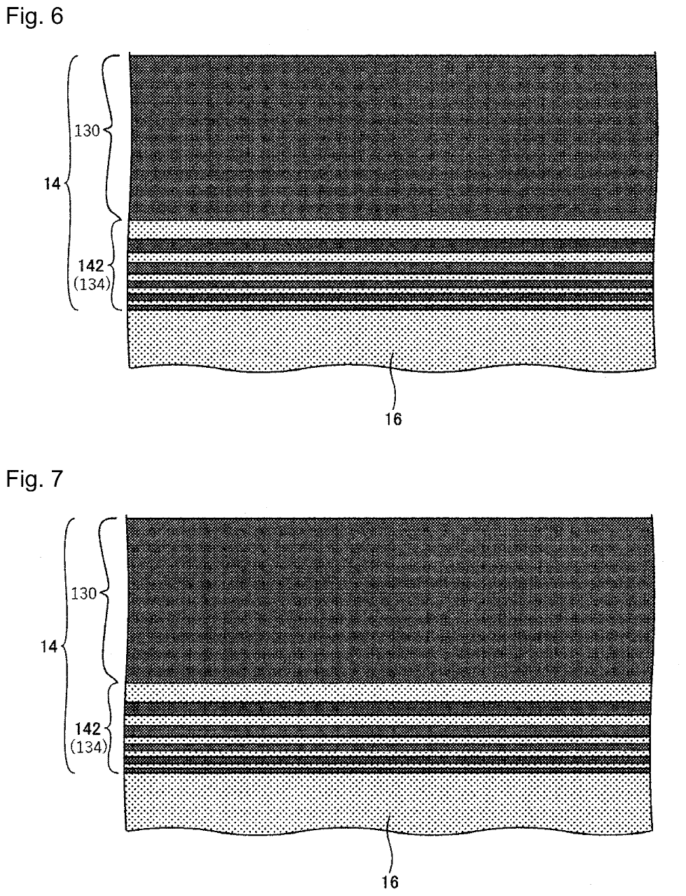

FIG. 5 to FIG. 7 are partial enlarged views showing other examples in the vicinity of the upper edge portion of laminated glass. As shown in FIG. 5, the first shielding layer 14 may have a dot area 141. That is, the first shielding layer 14 may have a semi-shielding portion 134, and the semi-shielding portion 134 may have a dot area 141. Here, in FIG. 5, the first shielding layer 14 has a shielding portion 130 in addition to the semi-shielding portion 134 (dot area 141). Further, as shown in FIG. 6 and FIG. 7, the first shielding layer 14 may have a stripe area 142. The semi-shielding portion 134 may have a stripe area 142. Further, in FIG. 6 and FIG. 7, the first shielding layer 14 has a shielding portion 130 in addition to the semi-shielding portion 134 (stripe area 142). In the plan view of the second glass plate 12, the periphery of the second shielding layer 15 (e.g. the periphery on the inside in-plane) may overlap with the dot area 141 or the stripe area 142 of the first shielding layer 14. In such a case, the periphery of the second shielding layer 15 is less noticeable, such being desirable from the viewpoint of the appearance.

The second shielding layer 15 may have a dot area 141 or a stripe area 142. That is, the second shielding layer 15 may have a semi-shielding area 134, and the semi-shielding area 134 may have a dot area 141 or a stripe area 142. In such a case, even if the dot area 141 overlaps with the periphery of the light control film 16 in the plan view of the second glass plate 12, the effect of shielding the periphery of the light control film 16 is obtainable in the same manner as in the case in FIG. 1A and FIG. 1B. In a plan view of the first glass plate 11, the periphery of the first shielding layer 14 (e.g. the periphery on the inside in-plane) may overlap with the dot area 141 or stripe area 142 of the second shielding layer 15. In such case, the periphery of the first shielding layer 14 is less noticeable, such being desirable from the viewpoint of the appearance.

The dot area 141 is an area in which a plurality of dots are arranged along the periphery of the first shielding layer 14 in a plan view. In the dot area 141, the shape and size of the dots can be decided as the case requires, and may, for example, be a circular shape with a diameter of about 0.5 mm to 2.5 mm or a semicircular shape with a diameter of half that. In the dot area 141, in the plan view, the dots are arranged, for example, equally spaced in multiple rows. In each row, the size and density of the dots may be varied. For example, the density of the dots may be adjusted so that the dots gradually become sparse toward the upper or lower side of the laminated glass 10 to form a gradation pattern. The design of the laminated glass 10 will be improved by having the dot area 141 in the first shielding layer 14.

The stripe area 142 is an area in which a plurality of lines are disposed as spaced apart along the periphery of the first shielding layer 14 in a plan view. In the stripe area 142, the plurality of lines may be parallel to the periphery of the first shielding layer 14, or may have a certain angle. Further, the number and width of the lines can be decided as the case requires, and, for example, the width of the lines can be made to be from 0.1 mm to 89.7 mm, and the spacing between the lines can be made to be from 0.1 mm to 89.7 mm. The density of the lines may be adjusted so that the lines gradually become sparse toward the upper or lower side of the laminated glass 10 to form a gradation pattern. The design of the laminated glass 10 will be improved by having the stripe area 142 in the first shielding layer 14.

Further, when the first shielding layer 14 has a dot area 141, the periphery of the dot area 141 near the shielding portion 130 may be a line connecting the tips of the dots that are farthest from the periphery of the first glass plate 11 among the plurality of dots. When the first shielding layer 14 has a stripe area 142, the periphery of the stripe area 142 near the shielding portion 130 may be the line farthest from the periphery of the first glass plate 11 (or the line connecting the tips of the lines if the lines are at a certain angle). The same applies to the second shielding layer 15. In the foregoing, the shielding layer in the vicinity of the upper edge portion of the laminated glass was explained by using FIG. 5 to FIG. 7, but the dot area 141 or the stripe area 142 may be provided only on the upper edge portion of the laminated glass, or only on one or both of side edge portions, or only on the upper edge portion and one or both of side edge portions.

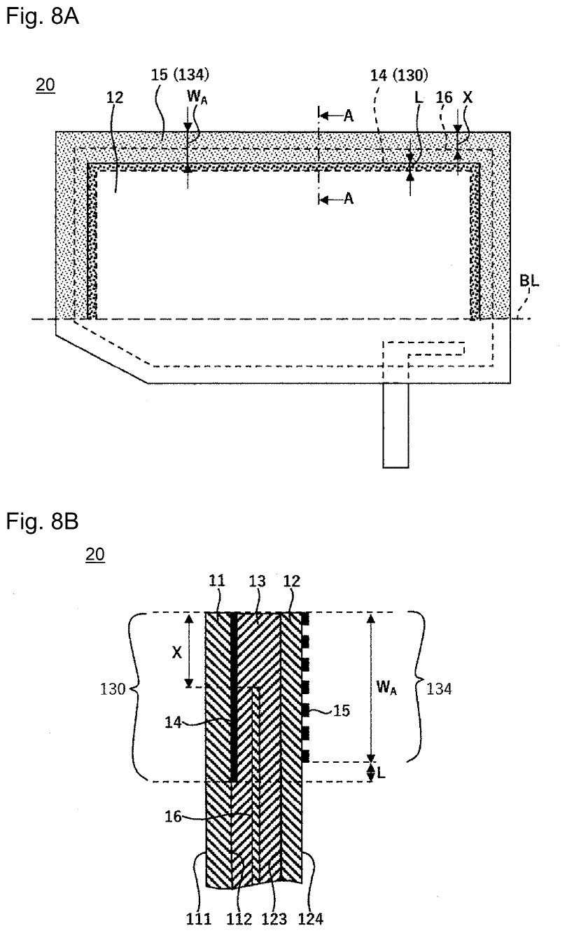

FIG. 8A and FIG. 8B are views illustrating laminated glass according to a modified example of the first embodiment. FIG. 8A is a view schematically showing the state where the laminated glass is viewed from the normal direction of the second glass plate, and FIG. 8B is a partially enlarged cross-sectional view along line A-A in FIG. 8A.

As shown in FIG. 8B, the laminated glass 20 is vehicular laminated glass having a first glass plate 11, a second glass plate 12, an interlayer 13, a first shielding layer 14, a second shielding layer 15, and a light control film 16. The laminated glass 20 has a lower edge portion located on the lower side when the laminated glass 20 is installed on a vehicle, an upper edge portion located on the upper side when the laminated glass 20 is installed on a vehicle, opposite the lower edge portion, and a pair of side edge portions connecting the lower edge portion and the upper edge portion. FIG. 8B is a cross-sectional view in the vicinity of the upper edge portion of the laminated glass 20.

Here, the laminated glass 20 differs from the laminated glass 10 in that, in the second glass plate 12, the peripheral portion of the fourth main surface 124 is not provided with a transmitting portion. Further, the laminated glass 20 differs in that the second shielding layer has a semi-shielding portion 134 inwardly in the plane direction from the periphery of the fourth main surface 124. With respect to other matters, the same applies as in the laminated glass 10, so the description of the laminated glass 10 will be applied.

In the example of in FIG. 8A and FIG. 8B, the first shielding layer 14 has a shielding portion 130. The second shielding layer 15 has a semi-shielding portion 134.

In the plan view of the second glass plate 12, the periphery of the light control film 16 at the upper edge portion of the laminated glass 20 overlaps with the first shielding layer 14. Further, in the plan view of the second glass plate 12, the periphery of the light control film 16 at the upper edge portion of the laminated glass 20 overlaps with the second shielding layer 15. Therefore, the peripheral portion of the light control film 16 can be prevented from being seen from the inside and the outside of the vehicle.

Further, at the fourth main surface 124 of the second glass plate 12, the second shielding layer 15 has a semi-shielding portion 134 at a portion in contact with the glass run. Therefore, the sliding noise caused by the friction between the glass run and the second shielding layer 15 is more likely to be reduced than a case where the second shielding layer 15 forms a shielding portion.

Here, the first glass plate 11, the second glass plate 12, and the interlayer 13 will be described in detail. In the following description, the description will be made by using laminated glass 10, but the following description can be applied to laminated glass 20 as well.

### [Glass Plates]

The first glass plate 11 and the second glass plate 12 may be made of inorganic glass or organic glass. As the inorganic glass, for example, soda-lime glass, aluminosilicate glass, borosilicate glass, alkali-free glass, quartz glass, etc. may be used without any particular restrictions. The first glass plate 11, which is located on the outside of the laminated glass 10, is preferably made of inorganic glass from the viewpoint of scratch resistance, and, from the viewpoint of formability, it is preferably made of soda-lime glass. In a case where the first glass plate 11 and the second glass plate 12 are formed of soda-lime glass, clear glass, green glass containing a least a certain amount of an iron component, and UV-cut green glass, can be used suitably. At least one of the first glass plate 11 and the second glass plate 12 may also be so-called privacy glass having a dark color such as gray. Privacy glass is described in detail, for example, in WO2015/088026, the contents of which may be used in this specification as reference.

The inorganic glass may be either untoughened glass or tempered glass. Untoughened glass is one made by forming molten glass into a plate, followed by annealing. Tempered glass is one having a compressive stress layer formed on the surface of untoughened glass.

Tempered glass may, for example, be either physically strengthened glass, such as wind-toughened glass, or chemically strengthened glass. In the case of physically strengthened glass, the glass surface can be strengthened by generating a compressive stress layer on the glass surface due to the temperature difference between the glass surface and the glass interior by operations other than annealing, for example, by rapidly cooling a uniformly heated glass plate from a temperature near its softening point in bending forming.

In the case of chemically strengthened glass, for example, the glass surface can be strengthened by inducing compressive stress on the glass surface by ion exchange after bending forming. Otherwise, glass that absorbs ultraviolet or infrared rays may be used. Further, the glass plate is preferably transparent, but a glass plate colored to such an extent that transparency is not impaired, may be used.

On the other hand, as materials for organic glass, transparent resins, such as a polycarbonate, e.g. an acrylic resin such as polymethyl methacrylate, polyvinyl chloride, polystyrene, etc. may be mentioned.

The forming method for the first glass plate 11 and the second glass plate 12 is not particularly limited, and, for example, in the case of inorganic glass, it is preferred to use a glass plate formed by the float method or the like. The shapes of the first glass plate 11 and the second glass plate 12 are not limited to rectangular or trapezoidal shapes, but may be shapes processed into various shapes and curvatures.

The thickness of the first glass plate 11 is preferably at least 1.1 mm and a most 3 mm at the thinnest portion. When the thickness of the first glass plate 11 is at least 1.1 mm, the strength of the laminated glass 10 is sufficient in terms of resistance to flying stones, etc., and when the thickness is at most 3 mm, the mass of the laminated glass 10 is not too large, which is desirable in terms of fuel consumption of the vehicle. The thickness of the first glass plate 11 is, at the thinnest portion, more preferably at least 1.8 mm and at most 2.8 mm, further preferably at least 1.8 mm and at most 2.6 mm, even more preferably at least 1.8 mm and at most 2.2 mm, still further preferably at least 1.8 mm and at most 2.0 mm.

The thickness of the second glass plate 12 is preferably at least 0.3 mm and at most 2.3 mm. When the thickness of the second glass plate 12 is at least 0.3 mm, the handling efficiency will be good, and when the thickness is at most 2.3 mm, the mass will not be too large.

Further, in a case where the thickness of the second glass plate 12 is not appropriate, if two pieces of glass with particularly deep bends as the first glass plate 11 and the second glass plate 12 are formed, a mismatch will be caused in the shapes of the two pieces, which will significantly affect the glass quality such as residual stress after crimping.

However, the glass quality, such as residual stress, can be maintained by adjusting the thickness of the second glass plate 12 to be at least 0.3 mm and at most 2.3 mm. To adjust the thickness of the second glass plate 12 to be at least 0.3 mm and at most 2.3 mm is particularly effective in maintaining glass quality in deeply bent glass. The thickness of the second glass plate 12 is more preferably at least 0.5 mm and at most 2.1 mm, further preferably at least 0.7 mm and 1.9 mm. Within such a range, the above effects will be more remarkable.

On the outside of the first glass plate 11 and/or the second glass plate 12, a film having water repellency, ultraviolet and infrared ray cutting functions, or a film having low reflective and low emissive characteristics, may be provided. Further, on the side in contact with the interlayer 13, of the first glass plate 11 and/or the second glass plate 12, a film that cuts ultraviolet or infrared rays, has low emissive properties or visible light absorptivity, or is colored, may be provided.

In a case where the first glass plate 11 and the second glass plate 12 are formed of curved inorganic glass, the first glass plate 11 and the second glass plate 12 are, after formed by the float process, bent and formed before bonding with the interlayer 13. Bending forming is conducted by softening the glass by heating it. The heating temperature of the glass during bending forming is preferably controlled in the range of approximately from 550° C. to 700° C. Gravity forming, press forming, roller forming, etc. may be used for bending forming of the first glass plate 11 and the second glass plate 12.

[Interlayer]

As the interlayer 13, thermoplastic resins are often used, and thermoplastic resins that have been used for this type of application, for example, a plasticized polyvinyl acetal resin, a plasticized polyvinyl chloride resin, a saturated polyester resin, a plasticized saturated polyester resin, a polyurethane resin, a plasticized polyurethane resin, an ethylene-vinyl acetate copolymer resin, an ethylene-ethyl acrylate copolymer resin, a cyclo-olefin polymer resin, ionomer resins, etc., may be mentioned. Further, a resin composition containing a modified block copolymer hydride as described in Japanese Patent No. 6065221 may also be suitably used.

Among these, plasticized polyvinyl acetal resins are suitably used, because they are excellent in balance of various properties such as transparency, weather resistance, strength, bonding strength, penetration resistance, impact energy absorption, moisture resistance, heat insulation, and sound insulation properties. These thermoplastic resins may be used alone, or two or more of them may be used in combination. The term “plasticized” in the above plasticized polyvinyl acetal resins means that they are plasticized by the addition of a plasticizer. The same applies to other plasticized resins.

However, when a certain material is to be sealed in the interlayer 13, depending on the type of the material to be sealed, it may be degraded by a certain plasticizer, and in such a case, it is preferred to use a resin that practically does not contain such a plasticizer. As the resin that does not contain a plasticizer, for example, an ethylene-vinyl acetate copolymer (EVA)-type resin or the like may be mentioned.

As the above polyvinyl acetal resins, a polyvinyl formal resin obtainable by reacting polyvinyl alcohol (PVA) with formaldehyde, a polyvinyl acetal resin in the narrow sense obtainable by reacting PVA with acetaldehyde, a polyvinyl butyral (PVB) resin obtainable by reacting PVA with n-butyl aldehyde, etc. may be mentioned, and PVB is particularly suitable, since it is excellent in balance of various properties, such as transparency, weather resistance, strength, bonding strength, penetration resistance, impact energy absorption, moisture resistance, heat insulation and sound insulation properties. Further, these polyvinyl acetal resins may be used alone, or two or more types may be used in combination.

However, the material for forming the interlayer 13 is not limited to a thermoplastic resin. The interlayer 13 may contain functional particles such as infrared absorbers, ultraviolet absorbers, luminescent agents, etc. Further, the interlayer 13 may have a colored portion called a shade band. The coloring pigment to be used to form the colored portion, may be one that can be used for plastics, and the amount of addition may be adjusted so that the visible light transmittance of the colored portion will be at most 40%, and, for example, an organic color pigment of azo type, phthalocyanine type, quinacridone type, perylene type, perinone type, dioxazine type, anthraquinone type, or isoindolino type, or an inorganic color pigment such as an oxide, a hydroxide, a sulfide, a chromate, a sulfate, a carbonate, a silicate, a phosphate, an arsenate, a ferrocyanide, carbon or metal powder may be mentioned. These color pigments may be used alone, or two or more types may be used in combination.

The interlayer 13 may have multiple layers. For example, the interlayer 13 may have three or more layers. For example, if the interlayer is formed of three or more layers and the shear modulus of any layer excluding both side layers is made to be smaller than the shear modulus of both side layers e.g. by adjusting the plasticizer, the sound insulation of the laminated glass 10 can be improved. In such a case, the shear modulus of both side layers may be the same or different.

The thickness of the interlayer 13 is preferably at least 0.5 mm at the thinnest portion. Here, in a case where the interlayer 13 has multiple layers, the thickness of the interlayer 13 is the total of the thicknesses of the respective layers. When the thickness of the thinnest portion of the interlayer 13 is at least 0.5 mm, the impact resistance required for laminated glass will be sufficient. Further, the thickness of the interlayer 13 is preferably at most 3 mm at the thickest portion. When the maximum value of the thickness of the interlayer 13 is at most 3 mm, the mass of the laminated glass will not become too large. The maximum value of the thickness of the intermediate film 13 is more preferably at most 2.8 mm, further preferably at most 2.6 mm.

Further, in a case where the interlayer 13 has multiple layers, the respective layers contained in the interlayer 13 are preferably formed of the same material, but may be formed of different materials. However, from the viewpoint of adhesion to the first glass plate 11 and the second glass plate 12, and functional material to be included in the laminated glass 10, it is desirable that the portion corresponding to at least 50% in the thickness of the interlayer 13 be formed of the above-mentioned materials.

To prepare an interlayer 13, for example, the above resin materials to become the interlayer are suitably selected and extrusion-molded in a heated molten state by using an extruder. The extrusion conditions such as an extrusion speed, etc. are set so that the interlayer 13 is uniformly prepared. Then, the extrusion-molded resin film is, for example, stretched as the case requires to give curvature to the upper and lower edges in accordance with the design of the laminated glass, to complete the interlayer 13.

[Laminated Glass]

The total thickness of the laminated glass 10 is preferably at least 2.8 mm and at most 10 mm. When the total thickness of the laminated glass 10 is at least 2.8 mm, sufficient rigidity can be secured. When the total thickness of the laminated glass 10 is at most 10 mm, sufficient transmittance can be obtained, and haze can be reduced.

On at least one side of the laminated glass 10, the plate misalignment between the first glass plate 11 and the second glass plate 12 is at most 1.5 mm, more preferably at most 1 mm. Here, the plate misalignment between the first glass plate 11 and the second glass plate 12 is the amount of deviation between the peripheral side surface of the first glass plate 11 and the peripheral side surface of the second glass plate 12 in a plan view.

On at least one side of the laminated glass 10, the plate misalignment between the first glass plate 11 and the second glass plate 12 is preferably at most 1.5 mm, in order not to spoil the appearance. On at least one side of the laminated glass 10, the plate misalignment between the first glass plate 11 and the second glass plate 12 is more preferably at most 1.0 mm, in order not to spoil the appearance. Here, on at least one side of the laminated glass 10, the plate misalignment between the first glass plate 11 and the second glass plate 12 may exceed 1.0 mm. At least one of the first glass plate 11 and the second glass plate 12 may have a through hole in order to firmly attach a holder 160, etc. as described later.

To produce the laminated glass 10, an interlayer 13 is sandwiched between the first glass plate 11 and the second glass plate 12 to form a laminate. And, for example, this laminate is placed in a rubber bag, rubber chamber or resin bag, and bonded in a vacuum having the gauge pressure controlled in the range of from −100 kPa to −65 kPa and controlling the temperature in the range of from about 70° C. to 110° C. The heating conditions, temperature conditions and laminating method may be selected as appropriate. The heating conditions, temperature conditions, and lamination method may suitably be selected.

After bonding, for example, by applying press-bonding treatment of heating and pressuring under conditions having the temperature controlled within a range of from 100° C. to 150° C. and the absolute pressure controlled within a range of from 0.6 MPa to 1.3 MPa, a laminated glass 10 more excellent in durability can be obtained. However, in some cases, there may be a case where this heating and pressurizing process may not be used in consideration for simplification of the process and the characteristics of the materials to be sealed in the laminated glass 10.

A method called “cold bending” may be used, in which one or both of the first glass plate 11 and the second glass plate 12 are bonded to each other in an elastically deformed state. Cold bending can be achieved by using a laminate consisting of the first glass plate 11, the interlayer 13, and the second glass plate 12 fixed by temporary fixing means such as a tape, and a conventionally known nip roller or pre-compression device such as a rubber bag, rubber chamber, etc. and an autoclave.

Between the first glass plate 11 and the second glass plate 12, to such an extent that the effects of the present application will not be impaired, in addition to the interlayer 13, there may be a film or a device having functions such as electric heating, infrared reflection, luminescence, power generation, light control, touch panel, visible light reflection, scattering, decoration, absorption, etc. Further, the surface of the laminated glass 10 may have a film having functions such as antifogging, water repellency, heat shielding, low reflection, etc. Further, the first main surface 111 of the first glass plate 11 and the fourth main surface 124 of the second glass plate 12 may have a film having functions such as heat shielding, heat emission, etc.

[Vehicular Window Structure]

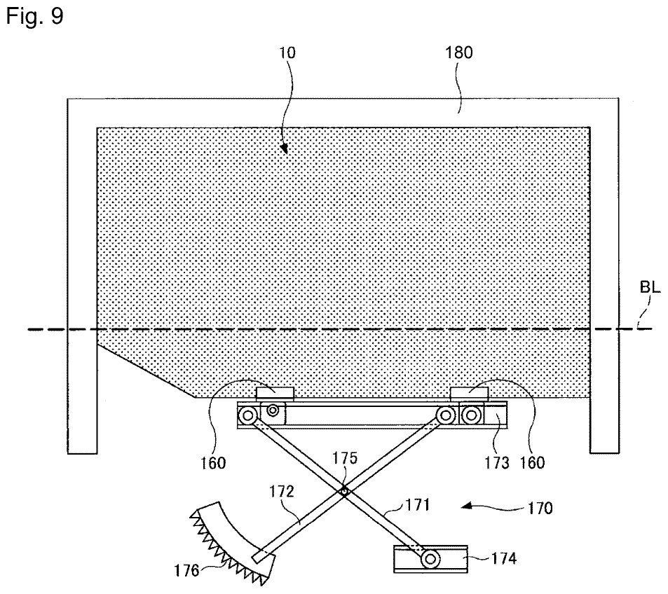

FIG. 9 is a schematic diagram illustrating a vehicular window structure. As shown in FIG. 9, in a case where the laminated glass 10 is a side door glass slidable in an up-and-down direction, a holder 160 and a lifting device 170 are disposed inside the door panel. Further, mainly above the lifting device 170, a glass run 180 that holds the upper edge portion and side edge portions on both sides of the laminated glass 10 is disposed. Here, although the details are omitted in FIG. 9, at the upper edge portion of the laminated glass 10, in the same manner as in the example shown in FIG. 4, the glass run 180 contacts only the transmitting portion 128, among the transmitting portion 128 of the fourth main surface 124 of the second glass plate 12 and the second shielding layer 15. The distance from the glass run 180 to the second shielding layer 15, i.e. the width of the transmitting portion 128 visible when the laminated glass 10 is viewed from the inside of the vehicle, may be at least 0 mm, but is preferably larger than 0 mm, and may be at least 1 mm, at least 2 mm, or at least 3 mm. When the distance from the glass run 180 to the second shielding layer 15 is made to be larger than 0 mm, the scratch resistance will be improved even when production errors or vibration of the vehicle during use are taken into consideration. The upper limit value of the width is not particularly limited, but may be, for example, at most 10 mm, at most 8 mm, or at most 6 mm. When the width is at most 10 mm, it is possible to suppress the deterioration of the appearance caused by the second shielding layer 15.

In FIG. 9, the laminated glass 10 slidable in an up-and-down direction, is shown in the completely closed state (i.e. the state positioned at the uppermost side). In the state shown in FIG. 9, the upper edge portion and the both side edge portions of the laminated glass 10 are held by the glass run 180. Here, even in a state where the laminated glass 10 is completely closed, the lower side of the laminated glass 10 below the belt line BL will not be exposed to the outside because it is located inside the door panel.

The holder 160 is a support member that slidably supports laminated glass 10. The holder 160 is made, for example, of urethane and supports at least one of the pair of glass plates. Specifically, the holder 160 supports, for example, the bottom edge of the laminated glass 10 and further extends from the bottom edge to the lower edge portion of the first glass plate and/or the second glass plate to support the lower edge portion of the first glass plate and/or the second glass plate. Alternatively, without supporting the bottom edge of the laminated glass 10, the holder 160 may support the laminated glass 10 by holding the pair of glass plates from both sides. Further, the material of the holder 160 is not limited to urethane.

The lifting device 170 is a device to lift and lower the laminated glass 10 by sliding it up and down along the glass run 180. The lifting device 170 is, for example, an arm-type regulator, consisting of two arms 171 and 172, a lifting rail 173, and a fixed rail 174. The holder 160 is mounted on the lifting rail 173 of the lifting device 170.

The two arms 171 and 172 are connected to each other, to be rotatable around a fulcrum 175. The lifting rail 173 is a rail that extends horizontally and can be raised and lowered against the vehicle door. The upper ends of the arms 171 and 172 are both horizontally slidably attached to the lifting rail 173. Further, the fixed rail 174 is a rail that extends horizontally and is fixed to the door of the vehicle.

The lower end of the arm 171 is attached horizontally slidably on the fixed rail 174, and the lower end of arm 172 is connected to a regulator via a gear 176. In such a construction, when the gear 176 is driven via the regulator, the arms 171 and 172 rotate around the fulcrum 175 to raise and lower the lifting rail 173. Here, the lifting device 170 is not limited to this construction, and may be a lifting device using wires, etc.

### Examples, Comparative Examples

In the following, Examples and Comparative Examples will be described, but the present invention is not limited to these Examples in any way. Ex. 1 and Ex. 4 are Examples of the present invention, and Ex. 2 and Ex. 3 are Comparative Examples.

### Ex. 1

Privacy glass with a thickness of 2 mm was prepared, respectively, as a first glass plate to become an outer plate (glass plate on the vehicle exterior side) when made into a laminated glass, and a second glass plate to become an inner plate (glass plate on the vehicle interior side) when made into a laminated glass. Further, as the interlayer, two PVB films (manufactured by Solutia Japan, RK11) with a thickness of 0.38 mm were prepared, and, as the light control film, a polymer dispersion liquid crystal (PDLC) film with a thickness of 0.4 mm was prepared.

As the first glass plate, a glass plate having a black ceramic printed as the first shielding layer on the second main surface, which becomes to be the vehicle interior side when made into a laminated glass plate, was used. As the second glass plate, a glass plate having a black ceramic printed as the second shielding layer on the fourth main surface, which becomes to be the vehicle interior side of the second glass plate when made into a laminated glass plate, was used. Here, the dimensional relations of the first shielding layer and the second shielding layer are as shown in Ex. 1 in Table 1 given later.

Next, the first glass plate, the first interlayer, the light control film, the second interlayer, and the second glass plate were placed in this order to prepare a laminate, and then bonded in a vacuum having the gauge pressure controlled in the range of from −100 kPa to −65 kPa and by controlling the temperature in the range of from about 70° C. to 110° C. Further, press-bonding treatment of heating and pressuring under conditions having the temperature controlled within a range of from 100° C. to 150° C. and the absolute pressure controlled within a range of from 0.6 MPa to 1.3 MPa, was conducted to prepare laminated glass.

### Ex. 2

Laminated glass was prepared in the same manner as in Ex. 1, except that the dimensional relationships of the first shielding layer and the second shielding layer were made to be as shown in Ex. 2 in Table 1 given later.

### Ex. 3

Laminated glass was prepared in the same manner as in Ex. 1, except that the dimensional relationships of the first shielding layer and the second shielding layer were made to be as shown in Ex. 3 in Table 1 given later.

### Ex. 4

Laminated glass was prepared in the same manner as in Ex. 1, except that the dimensional relationships of the first shielding layer and the second shielding layer were made to be as shown in Ex. 4 in Table 1 given later.

[Evaluations]

The laminated glass prepared in each of Ex. 1 to Ex. 4 was fitted to a door panel of a vehicle and repeatedly lifted up and down to conduct a lifting and lowering test. The laminated glass was raised and lowered 5,000 times while spraying a dust solution on each laminated glass after every 100 times of raising and lowering. The appearance of the laminated glass was visually checked after 5,000 times of raising and lowering, and if scratches were found on the fourth main surface of the second glass plate, the indication “unsuitable” was given, and if not, “suitable” was given. As the dust solution, water in which two or eight kinds of test powders specified in JIS Z 8901 revised in 2006 were dissolved, was used.

Further, the laminated glass made in each of Ex. 1 to Ex. 4 was placed in a thermostatic chamber at 90° C. and subjected to a heat resistance test. After 1,000 hours, each laminated glass was taken out from the thermostatic chamber and evaluated to see whether or not the deteriorated portions on the peripheral portion of the light control film are visible from the inside of the vehicle. Specifically, if the deteriorated portions of the light control film were visible beyond the second shielding layer as viewed from the inside of the car, the indication “unsuitable” was given, and if not, the indication “suitable” was given. Note that the laminated glass for the lifting and lowering test and the laminated glass for the heat resistance test were separately prepared.

TABLE 1

| | Ex. 1 | Ex. 2 | Ex. 3 | Ex. 4 |
|---|---|---|---|---|
| W_{A} [mm] | 20 | 20 | 10 | 30 |
| X [mm] | 3 | 3 | 6 | 3 |
| W_{A}-X [mm] | 17 | 17 | 4 | 27 |
| W_{B} [mm] | 5 | 2 | 5 | 10 |
| L [mm] | 4 | 4 | 4 | 4 |
| Lifting and lowering test | Suitable | Unsuitable | Suitable | Suitable |
| Heat resistance test | Suitable | Suitable | Unsuitable | Suitable |

As shown in Table 1, the results of the lifting and lowering test were such that Ex. 2 was “unsuitable”, and Ex. 1, 3 and 4 were “suitable”. That is, in Ex. 2, the width W_{B} of the transmitting portion, was as narrow as 2 mm, whereby the second shielding layer was scratched by contact with the glass run. On the other hand, in Ex. 1, 3 and 4, the width W_{B} of the transmitting portion was at least 5 mm, and the second shielding layer did not touch the glass run, whereby no scratches were observed.

Further, the results of the heat resistance test were such that Ex. 3 was “unsuitable”, and Ex. 1, 2, and 4 were “suitable”. That is, in Ex. 3, W_{A}−X was as narrow as 4 mm, whereby the second shielding layer could not conceal the deteriorated portions at the peripheral portion of the light control film, and the deteriorated portions were visible from the inside of the vehicle. On the other hand, in Ex. 1, 2 and 4, W_{A}−X was at least 17 mm, and the second shielding layer was able to sufficiently conceal the deteriorated portions at the peripheral portion of the light control film, whereby the deteriorated portions were not visible from the inside of the vehicle.

In the forgoing, the preferred embodiments, etc. have been described in detail, but without being limited to the above described embodiments, etc., various variations and substitutions may be made to the above described embodiments, etc., without departing from the scope of the claims.

### REFERENCE SYMBOLS

10, 20: Laminated glass
11: First glass plate
12: Second glass plate
13: Interlayer
14: First shielding layer
15: Second shielding layer
16: Light control film
111: First main surface
112: Second main surface
123: Third main surface
124: Fourth main surface
128: Transmitting portion
130: Shielding portion
134: Semi-shielding portion
141: Dot area
142: Stripe area
160: Holder
161,165: Transparent substrate
162,164: Conductive layer
163: Light control layer
166: Sealing material
170: Lifting device
171,172: Arm
173: Lifting rail
174: Fixed rail
175: Fulcrum
176: Gears

What is claimed is:

1. Vehicular laminated glass, which has a first glass plate and a second glass plate facing each other, an interlayer between the first glass plate and the second glass plate, and a light control film with switchable visible light transmission provided inside the interlayer,
which further has a lower edge portion to which wiring to the light control film is connected, an upper edge portion facing the lower edge portion, and side edge portions connecting the upper edge portion and the lower edge portion, wherein
the first glass plate has a first main surface located on the opposite side to the interlayer and a second main surface facing the interlayer,
the second glass plate has a third main surface facing the interlayer and a fourth main surface located on the opposite side to the interlayer,
which has a first shielding layer between the first main surface and the light control film, and a second shielding layer on the fourth main surface; and
which has the following structure A or structure B, wherein
in a plan view of the second glass plate, the periphery of the light control film at the upper edge portion overlaps the second shielding layer,
Structure A: At least either one of the side edge portions and the upper edge portion has a transmitting portion provided at the peripheral portion of the fourth main surface, and
at least a part of the shielding or semi-shielding portion formed by the second shielding layer is located inside the transmitting portion in the plane direction,
Structure B: The second shielding layer has a semi-shielding portion from the periphery of the fourth main surface toward inside in the plane direction.

2. The vehicular laminated glass according to claim 1, wherein the width of the second shielding layer is at least 3 mm and at most 35 mm.

3. The vehicular laminated glass according to claim 1, wherein in a plan view of the second glass plate, the distance between the periphery of the second shielding layer and the periphery of the light control film at the upper edge portion, is at most 10 mm.

4. The vehicular laminated glass according to claim 1, which satisfies W_{A}−X≥5, when the width of the second shielding layer is W_{A} [mm] and the distance between the periphery of the second shielding layer and the periphery of the light control film is X [mm].

5. The vehicular laminated glass according to claim 4, which satisfies W_{A}−X≤35.

6. The vehicular laminated glass according to claim 1, wherein in a plan view of the second glass plate, the distance between the inner edge of the second shielding layer and the inner edge of the first shielding layer is at least 0 mm and at most 10 mm.

7. The vehicular laminated glass according to claim 1, wherein the upper edge portion has the first shielding layer, the second shielding layer and the transmitting portion, and
at the upper edge portion, the width of the transmitting portion is at least 5 mm and at most 25 mm.

8. The vehicular laminated glass according to claim 7, wherein the side edge portions have the first shielding layer, and
the second shielding layer and the transmitting portion are provided only at the upper edge portion.

9. The vehicular laminated glass according to claim 1, wherein the side edge portions have the first shielding layer, the second shielding layer and the transmitting portion, and
at the side edge portions, the width of the transmitting portion is at most 3 mm.

10. The vehicular laminated glass according to claim 1, wherein the side edge portions have the first shielding layer, the second shielding layer and the transmitting portion, and
at the side edge portions, the width of the transmitting portion is at least 5 mm and at most 25 mm.

11. The vehicular laminated glass according to claim 1, wherein the side edge portions and the upper edge portion have the first shielding layer, the second shielding layer and the transmitting portion, and
at the side edge portions, the width of the transmitting portion is at least 5 mm and at most 25 mm, and
at the upper edge portion, the width of the transmitting portion is at most 3 mm.

12. The vehicular laminated glass according to claim 1, wherein the semi-shielding portion formed by the first shielding layer or the second shielding layer has a dot area or a stripe area.

13. The vehicular laminated glass according to claim 12, wherein the semi-shielding portion formed by the first shielding layer has the dot areas or the stripe areas, and
in a plan view of the second glass plate, the periphery of the second shielding layer overlaps the dot area or the stripe area of the first shielding layer, or
the semi-shielding portion formed by the second shielding layer has the dot area or the stripe area, and
in a plan view of the first glass plate, the periphery of the first shielding layer overlaps the dot area or the stripe area of the second shielding layer.

14. The vehicular laminated glass according to claim 1, wherein the light control film has two conductive-layer attached transparent substrates facing each other, and contains, between the two transparent substrates, at least one light control layer selected from a suspended particle device, a polymer dispersion liquid crystal, a polymer network liquid crystal, a guest host liquid crystal, photochromic, electrochromic, and electrokinetic.

15. The vehicular laminated glass according to claim 1, wherein the peripheral side surface of the light control film is sealed with a resin or adhesive tape.

16. The vehicular laminated glass according to claim 1, wherein the interlayer contains at least one resin selected from a plasticized polyvinyl acetal resin, a plasticized polyvinyl chloride resin, a saturated polyester resin, a plasticized saturated polyester resin, a polyurethane resin, a plasticized polyurethane resin, an ethylene-vinyl acetate copolymer resin, an ethylene-ethyl acrylate copolymer resin, and a cyclo-olefin polymer resin.

17. A vehicular window structure, which has the vehicular laminated glass as defined in claim 1, a support member that slidably supports the vehicular laminated glass, and a glass run that sandwiches the side edge portions and the upper edge portion.

18. The vehicular window structure according to claim 17, wherein the glass run is in contact with only the transmitting portion, among the transmitting portion and the second shielding layer in at least one of the side edge portions and the upper edge portion.

19. The vehicular window structure according to claim 18, wherein the distance between the glass run and the second shielding layer is at least 0 mm and at most 10 mm.
